(19) United States
(12) Patent Application Publication
(10) Pub. No.: US 2014/0022812 A1
(43) Pub. Date: Jan. 23, 2014

(54) DISPLAY FRONT LIGHTING DEVICE

(71) Applicants: Michael D. Andrich, Medina, OH (US); Peter W. Broer, Bratenahl, OH (US); Gregg M. Kloeppel, Sheffield Lake, OH (US)

(72) Inventors: Michael D. Andrich, Medina, OH (US); Peter W. Broer, Bratenahl, OH (US); Gregg M. Kloeppel, Sheffield Lake, OH (US)

(73) Assignee: LUMITEX, INC., Strongsville, OH (US)

(21) Appl. No.: 13/985,166

(22) PCT Filed: Feb. 22, 2012
(86) PCT No.: PCT/US12/25991

§ 371 Date: Sep. 17, 2013

Related U.S. Application Data
(60) Provisional application No. 61/446,715, filed on Feb. 25, 2011.

(51) Int. Cl. F21V 8/00

(52) U.S. Cl. CPC G02B 6/0031
USPC 362/603

(57) ABSTRACT

A display front lighting device comprises an optically transmissive sheet member that provides reflective means to evenly distribute light for the illumination of the text and/or graphics of display modules while permitting the text and/or graphics to visibly pass through the sheet member for viewing. The transmissive sheet member has LEDs offset mounted at an angle relative to one side of the sheet member such that a portion of the light emitted by the LEDs is reflected by the one side onto the adjacent dis play. The LEDs are mounted on a flexible printed circuit board, or alternatively on the conductive traces bonded to the sheet member.

### FIELD OF THE INVENTION

This invention relates generally to a display front lighting device for front lighting reflective display modules.

### BACKGROUND

E-readers and other handheld electronics devices widely marketed today are typically unlit. This enables use of e-ink and reflective displays with high contrast ratios which perform optimally in high ambient light conditions, and avoids the added cost and thickness of a backlight. Since these devices are also often used in low-light surroundings, however, it would be advantageous to be able to front light these devices with minimal image distortion in low-light conditions.

### SUMMARY OF INVENTION

The present invention relates to a device that provides for uniformly front lighting reflective display modules.

The display front lighting device comprises an optically transparent sheet member having opposite sides and one or more light emitting diodes (LEDs) that are offset from one of the sides at an angle sufficient to reflect certain light rays to illuminate an adjacent display area. These light rays then reflect back from the display area through the optically transparent sheet member to the user with minimal image distortion. More severe light ray angles can pass through the sheet member, or be masked to prevent glare in the user's eyes. Moreover, the sheet member may be provided with certain coatings, claddings or laminate to improve light reflection, while remaining optically transmissive to the returning light reflected from the display area.

Further, to make an integrated package, conductive traces can be bonded to the surface of the sheet member, and the LEDs can be bonded to the traces, creating an easily assembled integral module. This simplifies assembly to a display either as original equipment or optionally with a separate add-on bezel or flip attachment for use when needed.

The present invention can be used to front light display modules with bright, substantially uniform light in hand-held devices such as e-readers, cell phones, personal display assistants, hand-held computers, game devices, medical equipment, signage, or the like.

### BRIEF DESCRIPTION OF THE DRAWINGS

FIG. 1 is a schematic perspective view of one embodiment of a display front lighting device of the present invention.

FIG. 2 is a schematic perspective exploded view of the device of FIG. 1.

FIG. 3 is an enlarged schematic fragmentary transverse section through the device of FIG. 1.

FIG. 4 is an enlarged schematic fragmentary perspective view showing electrically conductive traces on the optically transparent sheet member of the device of FIG. 1.

FIG. 5 is a schematic front view of the device of FIG. 1 attached to a display module.

FIG. 6 is a schematic exploded perspective view of an assembly of the device of FIG. 1 and a display module.

FIG. 7 is an enlarged schematic fragmentary side view of the display front lighting device and display module of FIG. 5 and/or FIG. 6.

FIG. 8 is an enlarged schematic fragmentary partial section through another display front lighting device and adjacent display.

FIG. 9 is an enlarged schematic fragmentary section through an integrated multi-functional combined front and back dual directional lighting device of the present invention.

### DETAILED DESCRIPTION OF THE INVENTION

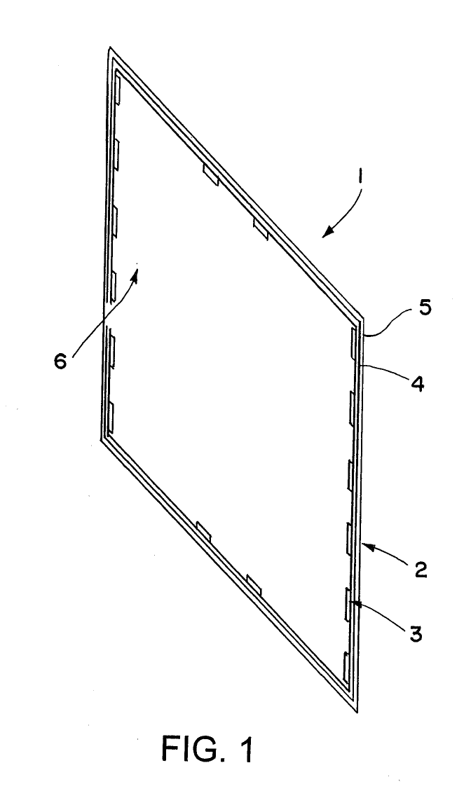

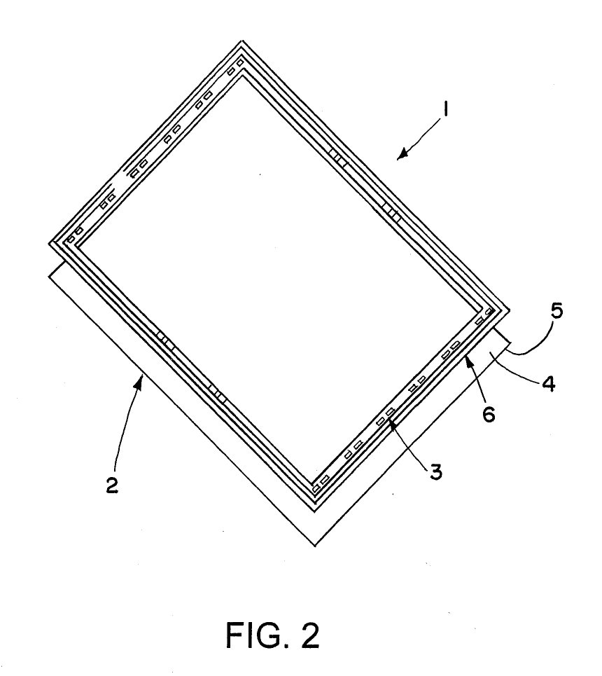

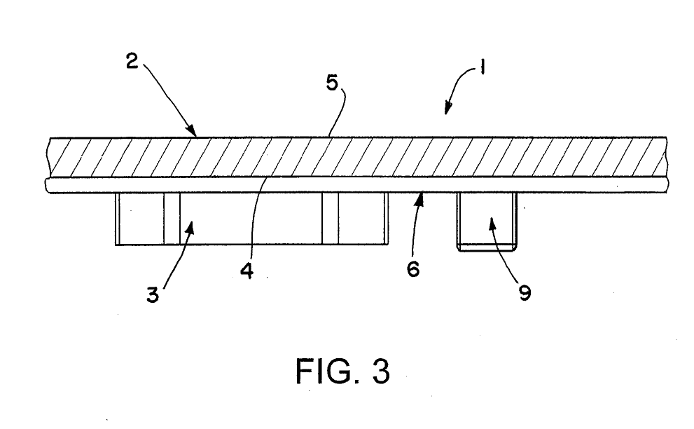

Referring to the drawings, their purpose is to illustrate one or more embodiments of the invention only and is not intended to limit the scope or spirit of the invention herein disclosed. FIGS. 1-3 schematically show a display front lighting device 1 comprising an optically transparent sheet member 2, with LEDs 3 offset-mounted at an angle relative to one of the sides 4 and 5 of the sheet member such that a portion of the light emitted by the LEDs is reflected by the one side onto an adjacent display area to illuminate same.

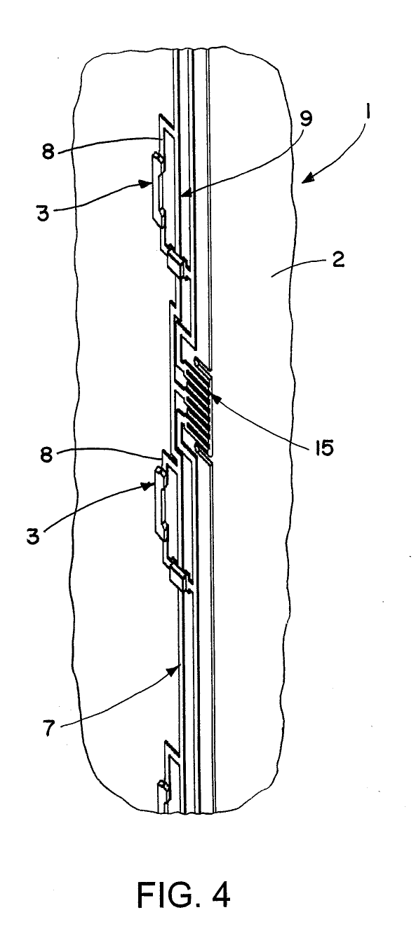

FIGS. 1-3 show the LEDs 3 mounted on a flexible optically transparent printed circuit 6, whereas FIG. 4 shows electrically conductive traces 7 and pads 8 bonded to the sheet member 2 for attaching the LEDs 3 to the sheet member. The LEDs are attached and positioned on the conductive traces or flexible printed circuit to provide a desired light distribution across an area of a display adjacent to the display front lighting device 1. The conductive traces provide a means of creating current limiting resistance to the LEDs. In one example, the conductive traces to each of the LEDs are equalized utilizing balancing resistors 9 thereby allowing uniform electrical power distribution to each of the

LEDs and providing uniform illumination from each of the LEDs. In another example, the conductive traces are varied to provide variable resistance, increasing brightness of the LEDs in selective areas of the sheet member as desired to optimize lighting uniformity on an adjacent display area. The LEDs are positioned at an angle sufficient to allow reflection of the less severe light ray angles, while more severe light ray angles are masked or pass through the sheet member 2 without causing glare to the user's eyes.

A connector interface 15 may be provided on the transparent sheet member 2 with the bonded conductive traces 7 providing a dockable direct attachment to external connectors for supplying electrical power to the LEDs (see FIG. 4).

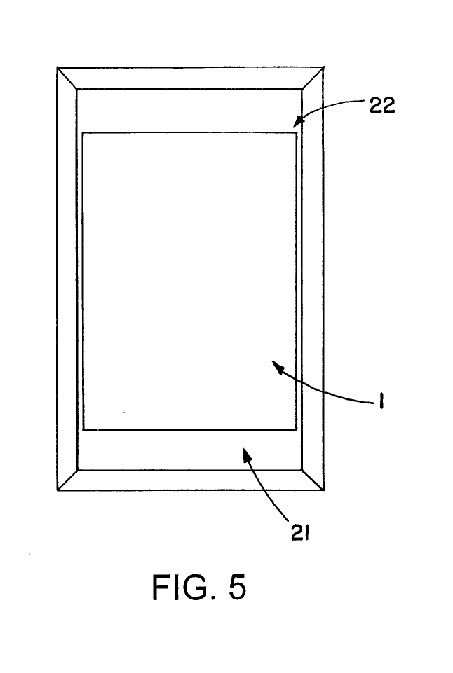

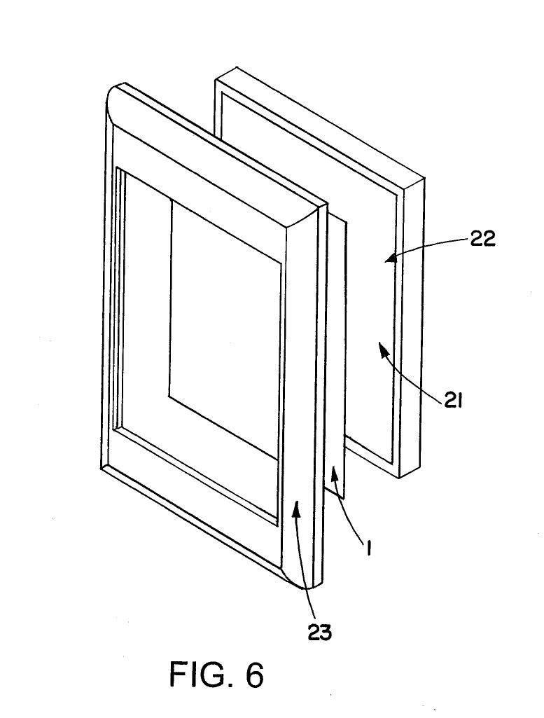

FIG. 5 shows the display front lighting device 1 removably attachable to a display module 21 for use in front lighting the text and/or graphic display area 22 of the display module whenever desired, whereas FIG. 6 shows an assembly of the display front lighting device 1 to a display module 21 as by means of a bezel 23.

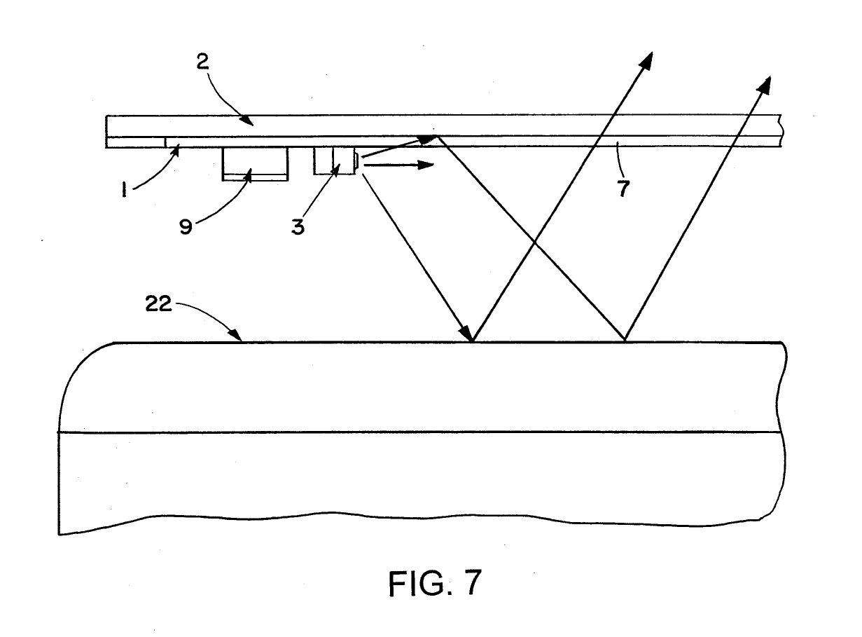

FIG. 7 shows exemplary light rays emitted by the LEDs 3 reflecting off of the transparent sheet member 2 of the device 1 to light the adjacent display area 22, and then reflecting back out through the transparent sheet member 2 to the user.

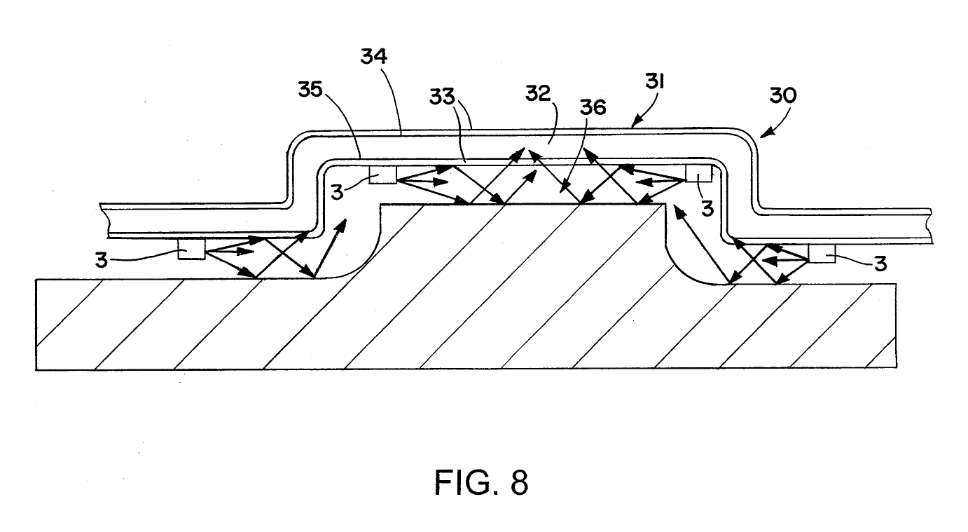

In an alternative embodiment shown in FIG. 8, the optically transparent sheet member 30 is comprised of clad optical fiber 31 with an optically transparent core 32 and optically transparent cladding 33 of a different index of refraction than the core on one or both sides 34, 35 of the core. This cladding provides an efficient reflection of light from the offset-mounted LEDs 3 onto an adjacent display area 36, and allows the placement of electrical traces onto the transparent sheet member without interrupting the optical path.

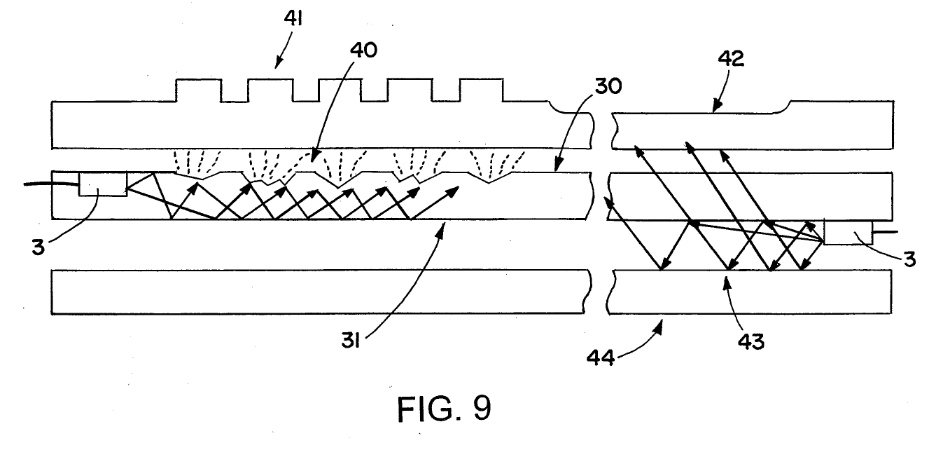

Using clad optical fiber as the sheet member 30 also enables the sheet member to be flat or formed into compound shapes such as shown in FIG. 8 that can be used to present a three-dimensional aspect to the user. Similarly, the use of clad optical fiber 31 as the sheet member 30 allows two-directional lighting by etching or otherwise disrupting the cladding to cause light traveling in the sheet member by total internal reflection to be emitted therefrom in one area 40 for example to backlight an overlay or switch mechanism 41, while leaving another area 42 optically transparent to front light an adjacent display area 43 of a display module 44 as shown in FIG. 9.

One or both sides of the sheet member of any of the foregoing embodiments may also be hard-coated to protect the sheet member from scratches, fingerprints and wear.

Although the invention has been shown and described with respect to a certain embodiments, it is obvious that equivalent alterations and modifications will occur to others skilled in the art upon the reading and understanding of the specification. In particular, with regard to the various functions performed by the above-described components, the terms used to describe such components are intended to correspond, unless otherwise indicated, to any component which performs the specified function of the desired component (e.g., that is functionally equivalent), even though not structurally equivalent to the disclosed component which performs the function of the herein disclosed exemplary embodiment of the invention. In addition, while a particular feature of the invention may have been disclosed with respect to only one embodiment, such feature may be combined with one or more other features as may be desired and advantageous for any given or particular application.

1. A display front lighting device comprising an optically transparent sheet member having opposite sides, and one or more LEDs offset at an angle relative to one of the sides of the sheet member such that a portion of the light emitted by the one or more LEDs is reflected by the one side of the sheet member to illuminate an adjacent display area.

2. The device of claim 1 overlying an adjacent display module including the adjacent display area, wherein the reflected light from the transparent sheet member illuminates text and/or graphics on the adjacent display area which is then reflected back through the sheet member with minimal image distortion.

3. The device of claim 1 further comprising electrically conductive traces bonded to the one side of the sheet member or on a flexible printed circuit overlying the one side, the one or more LEDs being in electrical communication with the conductive traces or the flexible printed circuit.

4. The device of claim 3 wherein the sheet member and the conductive traces provide a dockable attachment means to an external power source.

5. The device of claim 4 wherein the conductive traces provide a means of creating current limiting resistance to a plurality of LEDs.

6. The device of claim 5 wherein the conductive traces to each of the LEDs are equalized thereby allowing uniform electrical power distribution to each of the LEDs and providing uniform illumination from each of the LEDs.

7. The device of claim 5 wherein the conductive traces are varied to provide variable resistance, increasing brightness of the LEDs in selective areas of the sheet member as desired to optimize lighting uniformity on the adjacent display area.

8. The device of claim 1 wherein the sheet member comprises an optically transparent flat fiber having an optically transparent core with opposite sides, cladding on at least one of the sides, the cladding having a different index of refraction than the flat fiber core, and a plurality of LEDs offset at an angle relative to the one side of the flat fiber core such that a portion of the light emitted by the LEDs is reflected by the cladding on the one side to illuminate an adjacent display area.

9. The device of claim 8 wherein electrically conductive traces are bonded to the cladding on the one side of the flat fiber core, the conductive traces providing a means to attach the LEDs to the one side of the flat fiber.

10. The device of claim 1 wherein the sheet member comprises a contoured or formed optically transparent sheet member having opposite sides, and a plurality of LEDs are offset mounted at an angle relative to one of the sides of the sheet member such that a portion of the light emitted by the LEDs is reflected by the one side onto an adjacent display area.

11. The device of claim 10 overlying an adjacent display module including the adjacent display area, wherein the reflected light from the transparent sheet member illuminates text and/or graphics on the adjacent display area which is then reflected back through the sheet member with minimal image distortion.

12. An integrated, multi-functional combined front and back bi-directional lighting device comprising an optically transparent flat fiber having an optical transparent core with opposite sides, the sides of the flat fiber core being cladded by cladding made of optically transparent material having a different index of refraction than the flat fiber core, one or more LEDs offset at an angle relative to one of the sides of the flat fiber core such that a portion of the light emitted by the LEDs is reflected by the cladding on a first area on the one side to illuminate an adjacent display area, and an overlay or switch mechanism overlying a second area of the cladding on the other side of the flat fiber core that does not interrupt an optical path for viewing the display area through the flat fiber, the cladding of the second area being disrupted for causing light traveling in the flat fiber to be emitted therefrom to backlight the overlay or switch mechanism.
